(19) United States
(12) Patent Application Publication
(10) Pub. No.: US 2002/0184396 A1
(43) Pub. Date: Dec. 5, 2002

(54) Input control method, recording medium having stored therein program which can be executed under the input control method and server

(76) Inventor: Kazumi Fujikura, Tokyo (JP)

Correspondence Address: LAW OFFICE OF JOHN A. GRIECCI, 2201 E. WILLOW ST, STE D, PMB 344, SIGNAL HILL, CA, 90755, US

(21) Appl. No.: 09/981,346

(22) Filed: Oct. 16, 2001

(30) Foreign Application Priority Data
Jun. 4, 2001 (JP) 2001-168531

(51) Int. Cl. G06F 15/163; G06F 9/54; G06F 9/00

(52) U.S. Cl. 709/310

(57) ABSTRACT

There is described a server which is connected to a plurality of terminals and exchange data with the terminals. A paste field—into which there is to be pasted a multiple item display consisting of a set of single item displays, each representing a single matter—is displayed on a display section of the terminal. A single matter display window—which enables selection of a single matter corresponding to each single item display included in the multiple item display and which definitely displays the thus-selected single matter—is also displayed on the display section.

### BACKGROUND OF THE INVENTION

1. Field of the Invention

The present invention relates to an input control method for facilitating entry of data onto a WEB page on a WEB server by way of a WEB terminal, to a storage medium having stored therein a program which can be executed under the input control method, and to a server capable of executing the program.

2. Background Art

Widespread use of the Internet has recently become remarkable, and companies often place orders for products or parts by way of the Internet.

Under the current competitive environment in which special emphasis is placed on a company that has no stock of products or parts, enhancing the credibility of an Internet dealer in the eyes of corporations with regard to delivery time and quantity has become an important factor for receiving orders from the corporations by way of the Internet.

An Internet dealer—which encounters difficulty in achieving credibility with corporations with regard to delivery time and quantity—collects inventory information from small product/part supply manufacturers, which can become suppliers of a plurality of products or commodity products, and organizes the thus-collected inventory information items. Then, the inventory information items are disclosed to user corporations. On the basis of the thus-disclosed inventory information, user corporations place orders for products or parts. In such a situation, the manner of letting user corporations objectively know the credibility of small product/part supply manufacturers becomes significant. Consideration for such an issue is expected to become an important factor in sale of products or parts over the Internet in the future.

Inventory information about a sales dealer, such as an indefinite number of commodity products or parts, is posted on a WEB page of a related-art WEB server. The WEB page is made browsable for an indefinite number of users by way of their terminals. When sale of a product/part over the Internet by utilization of the WEB page is performed, accuracy of the inventory information becomes important.

A user ascertains the inventory information posted on the WEB server by way of his/her terminal. If the inventory information is out of date, the user may fail to purchase an anticipated number of products/parts on an anticipated date. In such a situation, it is easily predictable that a user who intends to procure parts without maintaining a stock may accept a great risk which would affect a production schedule.

Such a problem can be considered to be readily solved, by means of a manager of the WEB server updating inventory information in real time. However, real-time update of inventory information is very labor intensive and is nearly impossible in practice. According to a related-art method, inventory information stored in an inventory information database controlled by a supplier user is printed out. An operator enters the thus-printed inventory information into another database which differs from the inventory information database in terms of an entry form, such as the sequence of input items and the number of input items, through use of a terminal while glancing at the printout. Thus, input operation for updating inventory information is labor intensive.

A product/part supply manufacturer which sells products/parts to a user who posts inventory information on a WEB page of a WEB server usually sells products/parts by way of routes other than the WEB page. Thus, sale is effected not only by way of the WEB server but also by way of other routes. It cannot be denied that, at this point in time, sale of all products/parts by way of a manager of a WEB server poses a great business risk to a supply manufacturer.

The present inventor has conceived that the best solution is to cause a product/part supply manufacturer to update inventory information by utilization of a WEB terminal located at the manufacturer.

However, update of inventory information poses a troublesome problem to a small-scale corporation which is poor in human resources. A manager of a WEB server aiming for effecting Internet sales can compete with major product/part supply manufacturers who sell their products/parts by utilization of their own WEB servers, only when collectively dealing with an extremely large number of products or parts supplied by product/parts manufacturers.

In the light of the previously-described problems, the present inventor has conceived the present invention with a view towards providing a simple input control method which enables real-time and immediate update of data, by means of updating a WEB page on a WEB server through direct and immediate utilization of electronic inventory information possessed by a product/part manufacturer.

### SUMMARY OF THE INVENTION

Several factors must be taken into consideration in order to solve the foregoing problems. First, a plurality of input items pertaining to a “certain product or part” may be constituted of arrangement of numerals, Japanese Katakana characters, alphabets, letters, or other characters, and may change according to a “product/part supply manufacturer.” In order to enable a product/part supply manufacturer to utilize its electronic information, such as inventory information, in its present form or to enter electronic information, on a WEB page of a WEB server, there is a necessity of enabling identification of breakpoints provided in electronic information. Second, a plurality of input items pertaining to a “certain product/part” may consist of information items arranged in no particular order, and the order of input items may change according to a “product/part supply manufacturer.” For this reason, In order to enable a product/part supply manufacturer to utilize its electronic information, such as inventory information, in its present form or to enter electronic information, on a WEB page of a WEB server, there is a necessity for enabling ascertainment of input type of the information.

Against the foregoing backdrop, the present inventor has conceived a first invention. According to the first invention, the product/part supplier manufacturer is prompted to enter input item information constituted of numerals, Japanese Katakana characters, alphabets, letters, characters, or other symbols, in a predetermined format, such as PERL or text format, which can be converted by a variety of pieces of software, by means of pasting electronic inventory information owned by the product/part supplier manufacturer into an input field on a WEB page. Further,the product/part manufacturer enters delimiters into the electronic information. On the basis of the delimiters, the electronic information is ascertained on a per-unit input item basis. There is a high probability of input items changing from one product/part manufacturer to another manufacturer. Hence, the present inventor has conceived a second invention. According to the second invention, the type of an input item is selectively input by way of a type selection display window.

According to the first invention, if the delimiter has become clear and the electronic information can be ascertained on a per-unit input item, the information can be mechanically perceived through character recognition technology, because inventory information is previously made up of product numbers and models which are comprehensible for everyone. For instance, if an object of Internet sale is a semiconductor part and the model of the part is SRAM, it is evident for a user that the semiconductor part is static RAM. Product numbers are defined in a predetermined format unique to the manufacturer. So long as information about formats of product numbers has been prepared in a WEB server beforehand, all inventory information items pertaining to all product/part manufacturers can be collectively disclosed in a common format, by means of editing the layout of the input items through the input of automatic recognition.

According to the second invention, information usually offered to users from apart/product manufacturer is made common. Hence, input items pertaining to predictable information can be prepared beforehand in type-selection display windows. By means of preparing all predictable input items in respective type-selection display windows beforehand, the product/part supply manufacturer can be prompted to readily enter information with regard to the input items provided in the type-selection display window by utilization of a WEB terminal provided at the manufacturer.

More specifically, the present invention provides the following.

(1) A server which is connected to a plurality of terminals and exchanges data with the terminals, wherein

a display screen of each of the terminals displays a paste field to which is to be pasted a multiple item display made up of a set of single item displays, each representing a single matter, and a single-matter display window which enables selection of a single matter corresponding to a single item display included in the multiple item display and definite display of the selected single matter.

According to the invention described in (1), there is provided a paste field to which is to be pasted a multiple item display made up of a set of single item displays, such as a product number, the name of a manufacturer, price, and a delivery time, for displaying a single matter such as inventory information about, e.g., a semiconductor part. The meaning of sequence of the single item display pertaining to the single matter pasted to the paste field as a result of exchange of data with the terminal can be ascertained by the server, by means of the manufacturer selecting a single matter from the single-matter display window corresponding to each single item display included in the multiple item display. Hence, even when the arrangement of single item displays pertaining to single matters pasted in the paste field may change from one terminal to another, the server accurately ascertains the meaning of the single item display pertaining to a single matter. On the basis of the data collected from the plurality of terminals, there can be constructed a database in which a retrieved information item can be displayed on a display section of another terminal owned by the semiconductor part supply user.

(2) The multiple item display is created by means of arranging in a row a plurality of single item displays.

The invention described in connection with (2) yields an advantage of facilitating pasting operation as compared with a case where single item displays are provided in a plurality of columns.

(3) There is provided an input control method which enables collective input of input item information pertaining to a plurality of input items prepared in a predetermined format, such as a text format, on a WEB page by means of operation of a WEB terminal, the method comprising the steps of:

prompting entry of a delimiter for a plurality of input items at the time of collective input of the input item information, thereby distinguishing the input delimiter and enabling perception of the collectively-input input items in a divided manner on a per input item basis.

According to the invention described in connection with (3), a plurality of input items are cut or copied from previously-prepared input item information, and the thus-cut or copied input items are pasted, thus readily completing entry of a plurality of input items. More specifically, even if input item information about a plurality of input items consisting of arrangement of character strings is simply pasted, breakpoints among the thus-pasted input items of character strings cannot be identified. However, the present invention provides a delimiter in a breakpoint. An inquiry about a delimiter is posed to a user who is performing an input operation by way of a WEB terminal. The person is prompted to enter the delimiter. Regardless of whether a breakpoint between input items is a “comma” or a “space,” the WEB server monitoring the WEB page can discern the breakpoint.

In relation to a local network using a private communications line, limitation can be readily imposed on an input rule concerning input items which are prepared beforehand. The present invention has been conceived on the premise that information is input by means of an indefinite number of WEB terminals. Accordingly, difficulty is encountered in previously posing a limitation on an input format of input item information for which pasting operation is to be performed. Even when each of users who operate WEB terminals prepares different input item information for which pasting is to be performed, a delimiter can be ascertained, and each unit input item can be discerned, by means of posing an inquiry about the delimiter to the user of the WEB terminal, as in the case of the present invention.

(4) There is provided an input control method comprising an operation for preparing, beforehand, a plurality of input items to be input in a predetermined format, such as a text format, on a WEB terminal as input item information formed by consecutively arranging the input items in no particular order and an operation for enabling collective input of the plurality of input items in a row on a WEB page of a WEB server connectable to the WEB terminal by way of the Internet, through pasting operation of the WEB terminal, wherein

a plurality of type selection display windows equal in number with the input items are arranged in parallel with the input items in the vicinity of an input field where the input items are to be collectively input in a row, and

the type of each of the input items collectively input in the form of a row is input to the corresponding type selection display window.

According to the invention described in connection with (4), even when each of the users has prepared beforehand input item information by means of consecutively arranging a plurality of input items in no particular order in accordance with the user's own framework, the WEB server can identify input types of the input items consecutively input in the form of a row in no particular order, through use of the type selection display windows, even after the information has been collectively input through pasting operation.

Conversely, there is obviated a necessity of the WEB server managing the sequence of input items input by a WEB terminal. A WEB terminal is provided with an advantage of the ability to use data, such as an inventory control table prepared for another purpose, in their present form, to submit inventory information to potential users on the WEB page, and to prompt a user to place an order for products or parts.

(5) There is provided an input control method which enables collective input of input item information constituted of a plurality of input items previously prepared for placing an order for products by a WEB terminal into a WEB page from the WEB terminal in a predetermined format, such as a text format, through a pasting operation at the time of input of the input items into the WEB page of a WEB server by way of the WEB terminal, wherein

the input items mixedly comprise a plurality of types of input item information items, such as numbers, alphabets, letters, or Japanese Katakana characters; more specifically, product numbers, unit prices, quantities, and delivery times, and there is a possibility of the input items being consecutively arranged in a different order by each of the WEB terminals;

the WEB server prompts the user of the WEB terminal to enter a delimiter for the plurality of input items at the time of collective input of input items and can separately perceive the collectively-input input items on a per-unit input item basis by means of subjecting the input delimiter to discrimination processing; and

the WEB server arranges type selection display windows for use in selectively inputting input type, which windows are equal in number with the input items, in the vicinity of an input field on the WEB page where the input types of the input items are collectively input in a row during the collective input of input items, thereby prompting selective input of input type into the type selection window by way of the WEB terminal, and converts input information into a format formed by arrangement of uniform input items in accordance with the input type entered in the type selection display window, for ensuring consistency with information entered into the WEB page from another WEB terminal.

According to the invention described in (5), each of the WEB terminals (owned by users who sell their products) utilizes original data for inventory control, and consequently entry of inventory information into a WEB page of a WEB server becomes very easy. Even when the arrangement of input items differs from the manner of managing input items performed on another WEB terminal, the input types of the input items are identified individually. On the basis of the result of identification, the inventory information is converted into a common format having a common arrangement of input items. A user on a WEB terminal easily selects a desired product upon glancing at the WEB page converted into a common format and can be prompted to place an order for products.

(6) There is provided a storage medium having recorded thereon a program capable of executing an input control method which enables collective input of input item information pertaining to a plurality of input items prepared in a predetermined format, such as a text format, on a WEB page by means of operation of a WEB terminal, the method comprising the steps of:

prompting entry of a delimiter for a plurality of input items at the time of collective input of the input item information, thereby distinguishing the input delimiter and enabling perception of the collectively-input input items in a dividing manner on a per input item basis.

The present invention yields the same advantage as that yielded in the invention described in connection with (3).

(7) There is provided a storage medium having recorded thereon a program capable of executing an input control method comprising an operation for preparing, beforehand, a plurality of input items to be input in a predetermined format, such as a text format, on a WEB terminal as input item information formed by consecutively arranging the input items in no particular order, and an operation for enabling collective input of the plurality of input items in a row on a WEB page of a WEB server connectable to the WEB terminal by way of the Internet, through pasting operation of the WEB terminal, wherein

a plurality of type selection display windows equal in number with the input items are arranged in parallel with the input items in the vicinity of an input field where the input items are to be collectively input in a row, and

the type of each of the input items collectively input in the form of a row is input to the corresponding type selection display window.

The present invention yields the same advantage as that yielded in the invention described in connection with (4).

(8) There is provided a storage medium having recorded thereon a program capable of executing an input control method which enables collective input of input item information constituted of a plurality of input items previously prepared for placing an order for products by a WEB terminal into a WEB page from the WEB terminal in a predetermined format, such as a text format, through a pasting operation at the time of input of the input items into the WEB page of a WEB server by way of the WEB terminal, wherein

the input items mixedly comprise a plurality of types of input item information items, such as numbers, alphabets, letters, or Japanese Katakana characters; more specifically, product numbers, unit prices, quantities, and delivery times, and there is a possibility of the input items being consecutively arranged in a different order by each of the WEB terminals;

the WEB server prompts the user of the WEB terminal to enter a delimiter for the plurality of input items at the time of collective input of input items and can separately perceive the collectively-input input items on a per-unit input item basis by means of subjecting the input delimiter to discrimination processing; and

the WEB server arranges type selection display windows for use in selectively inputting input type, which windows are equal in number with the input items, in the vicinity of an input field on the WEB page where the input types of the input items are collectively input in a row during the collective input of input items, thereby prompting selective input of input type into the type selection window by way of the WEB terminal, and converts input information into a format formed by arrangement of uniform input items in accordance with the input type entered in the type selection display window, for ensuring consistency with information entered into the WEB page from another WEB terminal.

The present invention yields the same advantage as that yielded in the invention described in connection with (5).

(9) There is provided a WEB server which enables entry of electronic information from another WEB terminal by way of a communication line, such as the Internet, the server comprising

control means for effecting the operations of:

enabling collective input of input item information pertaining to a plurality of input items prepared in a predetermined format, such as a text format, on a WEB page by means of operation of a WEB terminal, while connection to the WEB terminal and authentication are taken as conditions;

prompting entry of a delimiter for plurality of input items at the time of collective input of the input item information; and

distinguishing the input delimiter and enabling perception of the collectively-input input items in a divided manner on a per input item basis.

According to the invention described in (9), there can be provided a server capable of yielding the same advantage as that yielded in the invention described in connection with (1), while authentication is taken as a condition.

(10) There is provided a WEB server which enables entry of electronic information from another WEB terminal by way of a communication line, such as the Internet, the server comprising

control means for effecting the operations of:

enabling collective input of input item information which has been prepared beforehand on a WEB terminal and is formed by means of consecutively arranging, in no particular order, a plurality of input items to be input in a predetermined format, such as a text format, on a WEB page of the WEB server by means of operation of the WEB terminal and through pasting operation while connection to the WEB terminal and authentication are taken as conditions;

displaying on a display section of the WEB terminal a plurality of type selection display windows which are equal in number with the input items and are arranged in parallel with the input items in the vicinity of an input field where the input items are to be collectively input in a row;

prompting input, to each of the type selection display windows, of type of each of the input items collectively input in the form of a row; and

storing the input type selectively input to the type selection display window in association with a corresponding input item.

According to the invention described in (10), there can be provided a server capable of yielding the same advantage as that yielded in the invention described in connection with (2), while authentication is taken as a condition.

(11) There is provided a WEB server which enables entry of electronic information from another WEB terminal by way of a communication line, such as the Internet, the server comprising

control means for effecting the operations of:

prompting collective input of input item information constituted of a plurality of input items previously prepared for placing an order for products by a WEB terminal into a WEB page from the WEB terminal in a predetermined format, such as a text format, through a pasting operation at the time of input of the input items into the WEB page of a WEB server by way of the WEB terminal while connection to the WEB terminal and authentication are taken as conditions; and wherein

the input items mixedly comprise a plurality of types of input item information items, such as numbers, alphabets, letters, or Japanese Katakana characters; more specifically, product numbers, unit prices, quantities, and delivery times, and there is a possibility of the input items being consecutively arranged in a different order by each of the WEB terminals; and

the control means prompts the user of the WEB terminal to enter a delimiter for the plurality of input items at the time of collective input of input items and can separately perceive the collectively-input input items on a per-unit input item basis by means of subjecting the input delimiter to discrimination processing; and

the control means transmits to the WEB terminal an image showing type selection display windows for use in selectively inputting input type, which are equal in number with the input items and are arranged in the vicinity of an input field on the WEB page where the input types of the input items are collectively input in a row during the collective input of input items, thereby prompting selective input of input type into the type selection window by way of the WEB terminal, and converts input information into a format formed by arrangement of uniform input items in accordance with the input type entered in the type selection display window, for ensuring consistency with information entered into the WEB page from another WEB terminal.

According to the invention described in (11), there can be provided a server capable of yielding the same advantage as that yielded in the invention described in connection with (3), while authentication is taken as a condition.

According to the servers described in connection with (9) through (11), after completion of establishment of connection to a WEB terminal and completion of authentication, the WEB terminal is prompted to update entry to a plurality of input items or newly input information, thereby enabling input of information about the plurality of input items. The reason for this is that consideration is given for preventing unauthorized personnel from entering information through use of a WEB terminal for causing an external WEB terminal to enter a plurality of input items, such as inventory information.

Here, the expressions “type selection display windows” and “single matter display windows” employed in the present invention mean windows to be used for indicating predictable input items on the WEB page through use of symbol T shown in FIGS. 7 and 8. From a plurality of input items placed in the field designated by symbol T, one is selected by input means of the WEB terminal, and the thus-selected input item is input. In this way, information about the nature of the respective input items arranged on the WEB page through pasting operation is selected from the plurality of input items prepared by the WEB server beforehand, by means of the input means of the WEB terminal. There is no necessity of an input operator of the WEB terminal entering input items one by one, and thus an input operation is facilitated. Finally, the present invention compiles the data input from the plurality of WEB terminals into a retrievable database. Respective product/part supply manufacturers perform retrieval and extraction operations, thereby offering posting of information to users, such as inventory information, in accordance with a request from a user. Thus, there can be prevented occurrence of a risk of hindrance of compilation of information into a database or retrieval of information, which would otherwise be caused when expressions of input items change from one WEB terminal to another WEB terminal.

In relation to the above-described inventions, the expression “collective input (entry)” means input of at least two input items through a single paste operation. The expression is not limited to collective input of all input items representing one object pertaining to certain inventory information.

### BRIEF DESCRIPTION OF THE DRAWINGS

FIG. 1 is a block diagram showing the configuration of a communications network according to the present invention;

FIG. 2 is a block diagram showing the configuration of a portable terminal serving as a WEB terminal according to the present invention;

FIG. 3 is a block diagram showing the configuration of a personal computer serving as a WEB terminal according to the present invention;

FIG. 4 is a block diagram showing the configuration of a server according to the present invention;

FIG. 5 is a schematic descriptive view showing a trading scheme according to the present invention;

FIG. 6 is a descriptive view showing a WEB page according to the present invention;

FIG. 7 is a descriptive view showing the WEB page according to the present invention;

FIG. 8 is a descriptive, partially-enlarged view of the WEB page shown in FIG. 7; and

FIG. 9 is a flowchart showing flow of inventory information registration operation according to the present invention.

### DETAILED DESCRIPTION OF THE PREFERRED EMBODIMENTS

By reference to the accompanying drawings, there will now be described a mode of execution suitable for use with a network system to which is applied a server capable of executing an inventory information input control method according to the present invention using a wide-area network, such as the Internet.

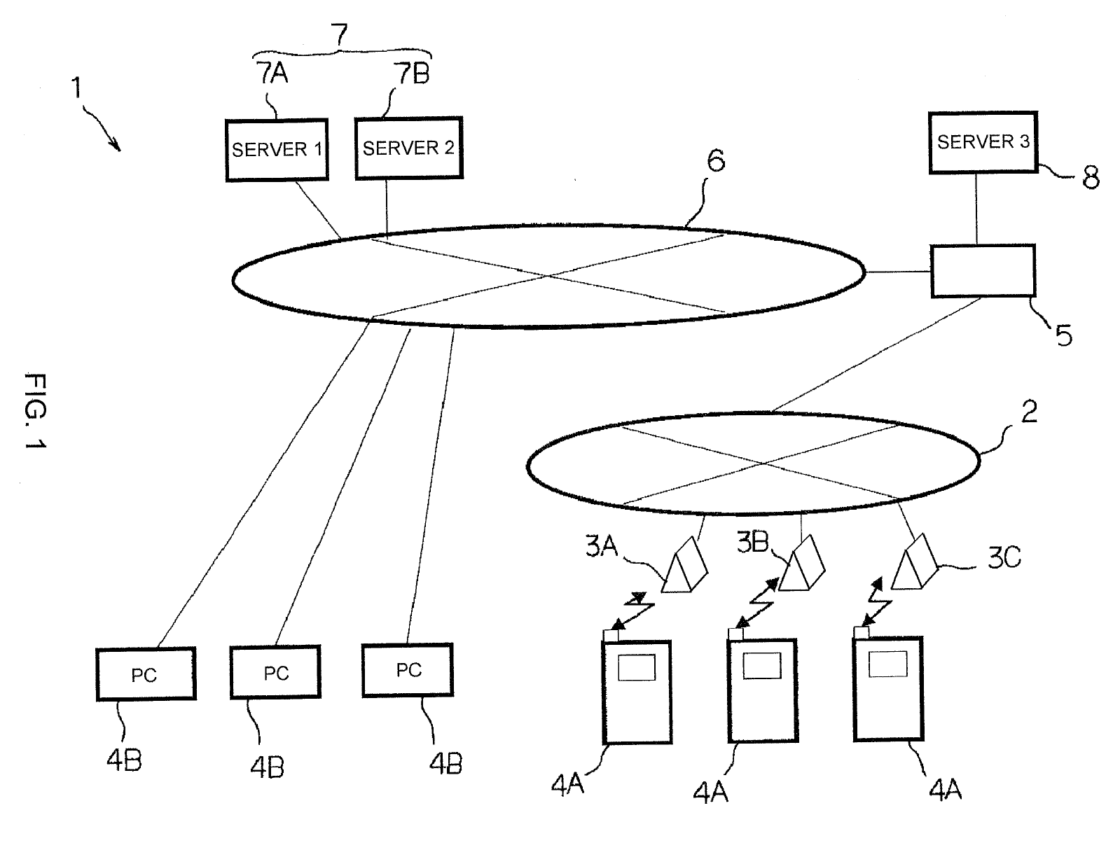

FIG. 1 is a block diagram showing the configuration of a network system 1 to which is applied a server capable of executing an inventory information input control method according to the present invention using a wide-area network, such as the Internet.

In relation to the network system 1 shown in FIG. 1, portable terminals 4A . . . 4A possessed by an indefinite number of users are connected to a packet network/PDC (personal digital cellular) network 2 by way of cell sites 3A, 3B, 3C, . . . . Further, personal computers 4B owned by an indefinite number of users are connected to an Internet network 6.

Here, in terms of a server manager, the users include “product/part supply manufacturers (hereinafter called “supplier users”) and corporation users (hereinafter called “supplied users”) which are clients of the supplier users.

Here, the portable terminal 4A is a Zaurus (produced by Sharp) or a popular input terminal produced by another manufacturer. In the present embodiment, as will be described later, an input terminal of any type can be adopted as a WEB terminal according to the present invention, so long as the input terminal enables entry of inventory management data stored in the terminal into a WEB page on a WEB server connected to the Internet or a like network. In consideration of the performance of the portable terminal 4A at this point in time, using the personal computer 4B as a WEB terminal is more preferable than using the portable terminal 4A.

WEB terminals, such as the portable terminals 4A or the personal computers 4B, can exchange sound or character data with each other over a communication line network, such as the packet network/PDC network 2 or the Internet, by means of the time division multiple access (TDMA) scheme. The portable terminals 4A can access an information center 5 through packet communication by way of the packet network/PDC network 2, as well as mutual exchange character data, such as numerals, letters, and Japanese Katakana characters, or image data. In accordance with a request output from the portable terminal 4A, the information center 5 acquires various information items from servers 7A and 7B connected to the Internet 6 or from a server 8 connected to the information center 5 by way of a private line. The information center 5 offers the thus-acquired information to the portable terminal 4A that has originated the request. Here, the portable terminal 4A is a WEB terminal in a shared WWW information system which can use another computer by way of a network, and the server 8 is a WEB server in the shared WWW information system. Hence, data can be input or entered into a WEB page in the server 8 by means of operation of input means of the portable terminal 4A. Likewise, the personal computer 4B operates as the WEB terminal and can input data into a WEB page in the server 8.

Either the server 7 (consisting of the servers 7A and 7B) or the server 8 connected to the information center 5 by way of a private line can be adopted as a server capable of executing an input control method using a wide-area network, such as the Internet.

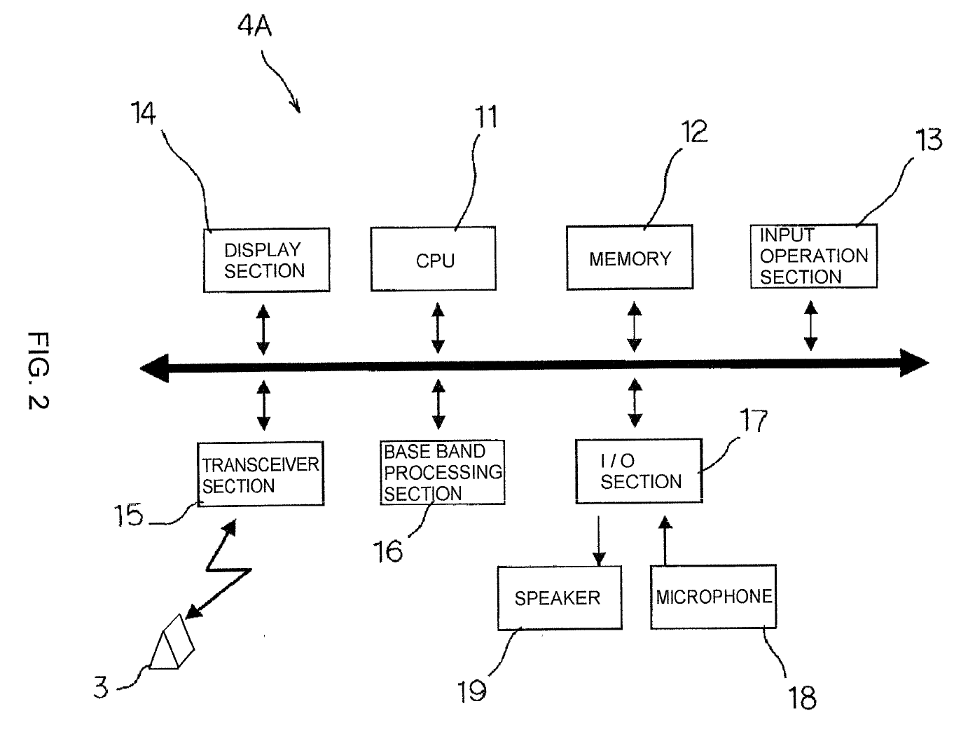

FIG. 2 is a block diagram showing the configuration of the portable terminal 4A possessed by the supplier user or the supplied user. As shown in FIG. 2, the portable terminal 4A comprises a CPU 11; memory 12; a transceiver (RF) section 15 for exchanging a signal with the cell sites 3A, 3B, 3C, . . . ; a base band processing section 16 which converts an RF signal received by the transceiver section 15 into a base band signal and which converts a base band signal to be sent into an RF signal; a sound input processing section serving as an interface to a microphone 18 and a speaker 19; a display section 14 constituted of a liquid-crystal display panel, and an input operation section 13 serving as input means such as a mouse or a keyboard. These elements are connected to a data bus BUS.

The CPU 11 is designed so as to operate in various manners in accordance with an operation program stored in the memory 12. The CPU 11 controls circuit sections in accordance with operation. Details about processing performed by the CPU 11 are displayed on the display section 14, as required.

When a user enters a phone number of a desired destination (e.g., an Internet provider or a portable cellular phone), the input operation section 13 supplies data representing the phone number to the CPU 11. The CPU 11 sends a connection request to the destination represented by the phone number entered by the user, by way of the transceiver section 15. At this time, the packet network/PDC network 2 establishes line connection in accordance with a response from the destination. When line connection has been established, the transceiver section 15 supplies an RF signal received from the destination by way of an antenna to the base band processing section 16, where the RF signal is converted into a base band signal. The base band processing section 16 supplies the resultant base band signal to an I/O section 17. As a result, a sound signal transmitted from the destination is output as sound by way of the speaker 19, or a video signal transmitted from the destination is displayed on the display section 14.

When a user inputs sound by way of the microphone 18, the I/O section 17 supplies an input sound signal supplied from the microphone 18 to the base band processing section 16, where the base band signal is converted into an RF signal. The base band processing section 16 transmits the RF signal to the destination connected to the packet network/PDC network 2 by way of the transceiver section 15. The user using the portable terminal 4A can establish communication with a portable terminal of another user; that is, the destination.

Internet Explorer (product name) is stored as communications software in the memory 12. The information sent from the servers 7 and 8 is displayed on the display section 14 by use of the communications software. Data entry, such as rewriting of a WEB page in the server 7 or 8, can be performed by means of operation of the input operation section 13 of the portable terminal 4A.

Spreadsheet software, such as Excel (product name), is stored in the memory 12 of the portable terminal 14 of the supplier user. An inventory information database constructed by means of the spreadsheet software is stored in the memory 12. On the basis of the inventory information stored in the database, the inventory information constructed by Excel is collectively input to a plurality of input items required for inputting data into a WEB page, by means of copy-and-paste operations through actuation of a mouse of the input operation section 13. Detailed explanation of this operation will be provided later.

More specifically, after having converting into packet data various electronic information items entered as a result of the user actuating the input operation section 13, the CPU 11 transmits the packet data to the packet network/PDC network 2 by way of the base band processing section 16 and the transceiver section 15. The packet network/PDC network 2 transmits the packet data to the information center 5. Further, an RF signal—which has been transmitted from the information center 5 by way of the packet network/PDC network 2 and on which the packet data are superimposed—is acquired by way of the transceiver section 15 and the base band processing section 16, and the RF signal is displayed on the display section 14.

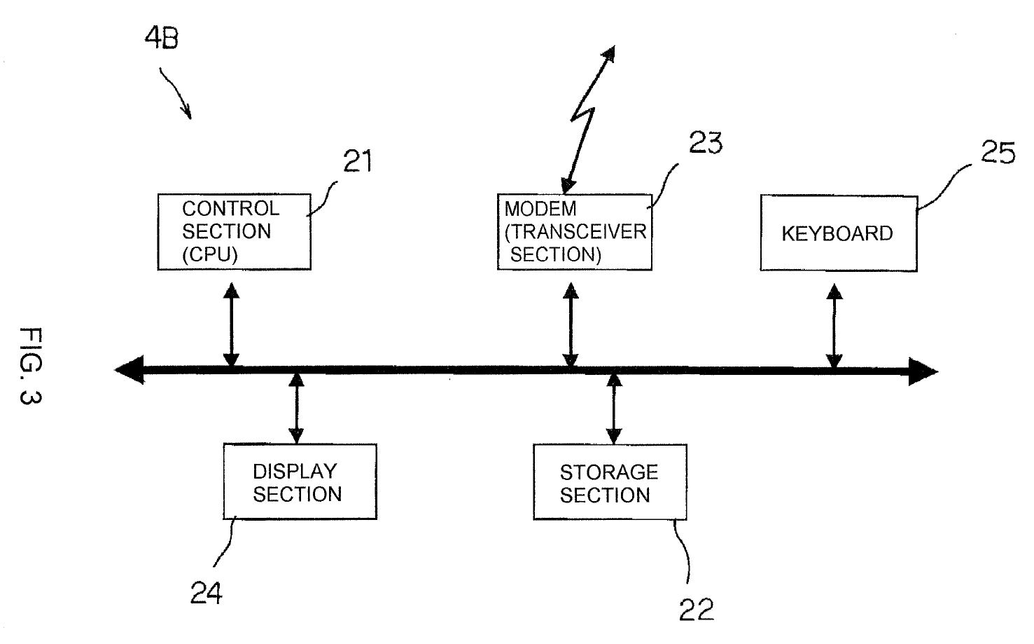

FIG. 3 is a block diagram showing the configuration of the personal computer 4B which is a WEB terminal provided at each of the supplier users and the supplied users. As shown in FIG. 3, the personal computer 4B comprises a CPU 21; a storage section 22 such as memory or a hard disk drive; a modem 23; a display section 24 such as a CRT or a liquid-crystal display; and an input operation section 25 serving as input means such as a keyboard and a mouse, all of which are connected to a data bus. By means of a communication program such as Internet Explorer stored in the memory 22, the CPU 21 is connected to the servers 7, 8 via the modem 23 by way of a communications line network. In a connected state, the personal computer 4B can exchange various electronic information items with the servers 7 and 8, as does the portable terminal 4A serving as a WEB terminal.

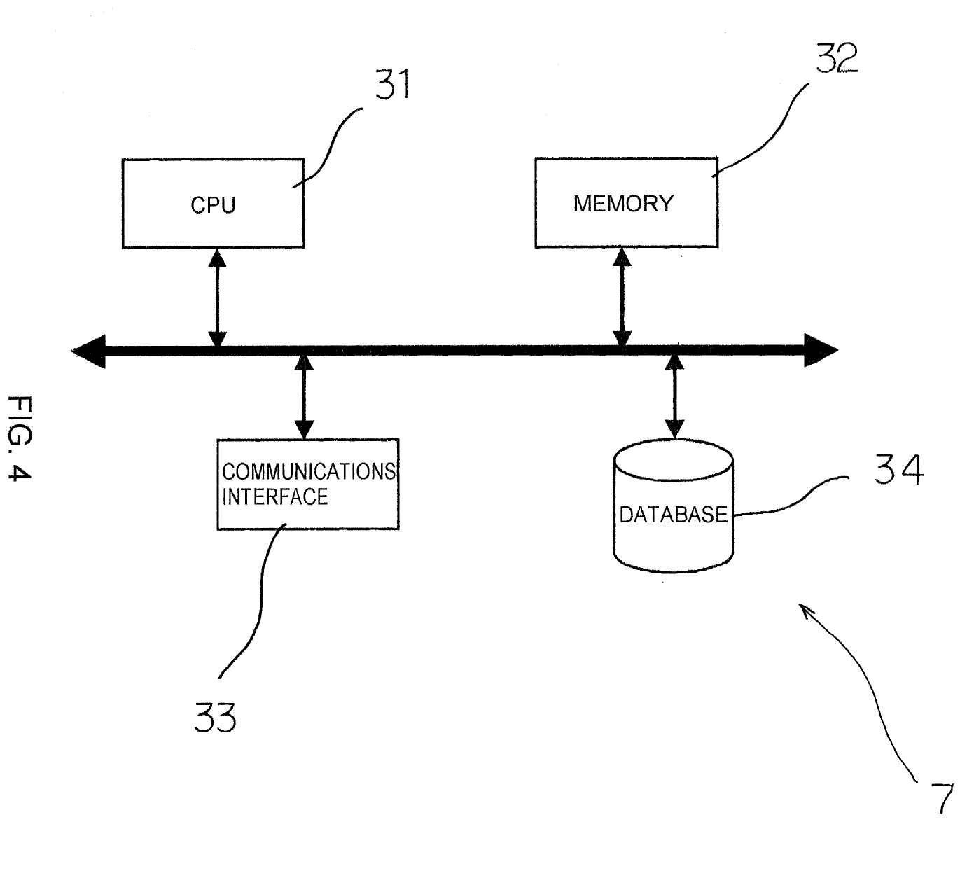

FIG. 4 is a block diagram showing the configuration of the server 7. As illustrated, the server 7 comprises a CPU 31; memory 32; a communications interface 33; and a database 34, all of which are connected to a data bus BUS. In accordance with a control program stored in the memory 32, the CPU 31 performs various processing operations.

The CPU 31 receives information entered by way of the WEB terminals 4 (the portable terminal 4A and the personal computer 4B), by way of the Internet 6 connected to the communications interface 33. The input information items are stored in the memory 32. Of the thus-stored information items, certain information items required to be compiled into a database are stored in the database 34.

The control program includes a system program serving as an OS; an authentication program for determining whether or not an access is made by an authentic supplier user or supplied user by way of the WEB terminal 4 (i.e., 4A or 4B); a transmission program for transmitting and receiving electronic information to and from the WEB terminal 4; a guide program for causing a user to enter onto a WEB page inventory information about semiconductor components; an automatic database edition program which prompts a user to enter inventory information and automatically compiles results of input to a plurality of input items concerning the inventory information items received from a plurality of WEB terminals 4 into a database; and a deadline control program for controlling deadline of the input inventory information.

A control section is constituted of the control program and the CPU 31. As will be described later, the control section receives the inventory information from a plurality of supplier users by way of the WEB terminals 4; compiles the thus-received information into a database which can be retrieved by a plurality of supplied users; prompts the supplied users to retrieve inventory information compiled into the database; discloses display data generated on the basis of retrieval results to the supplied users by way of the WEB terminals 4; and inquires about the necessity of preparation of a cost estimate. Thus, the WEB manager acts as a middle man between a supplier user and a supplied user. Simply speaking, the WEB server 7 including the control section plays a role of a net wholesale dealer. The server 8 differs from the server 7 only in that the server 8 is connected to a network by means of a private line. In other respects, the server 8 is identical in configuration with the server 7, and hence repetition of detailed explanation is omitted.

The memory 32 stores ID information (i.e., an address, a phone number, information about a transaction history, corporation information, an ID code, and a password) pertaining to each of the supplier users and the supplied users, and display screen data which can be displayed on each of the display sections 14 and 24 of the WEB terminals 4.

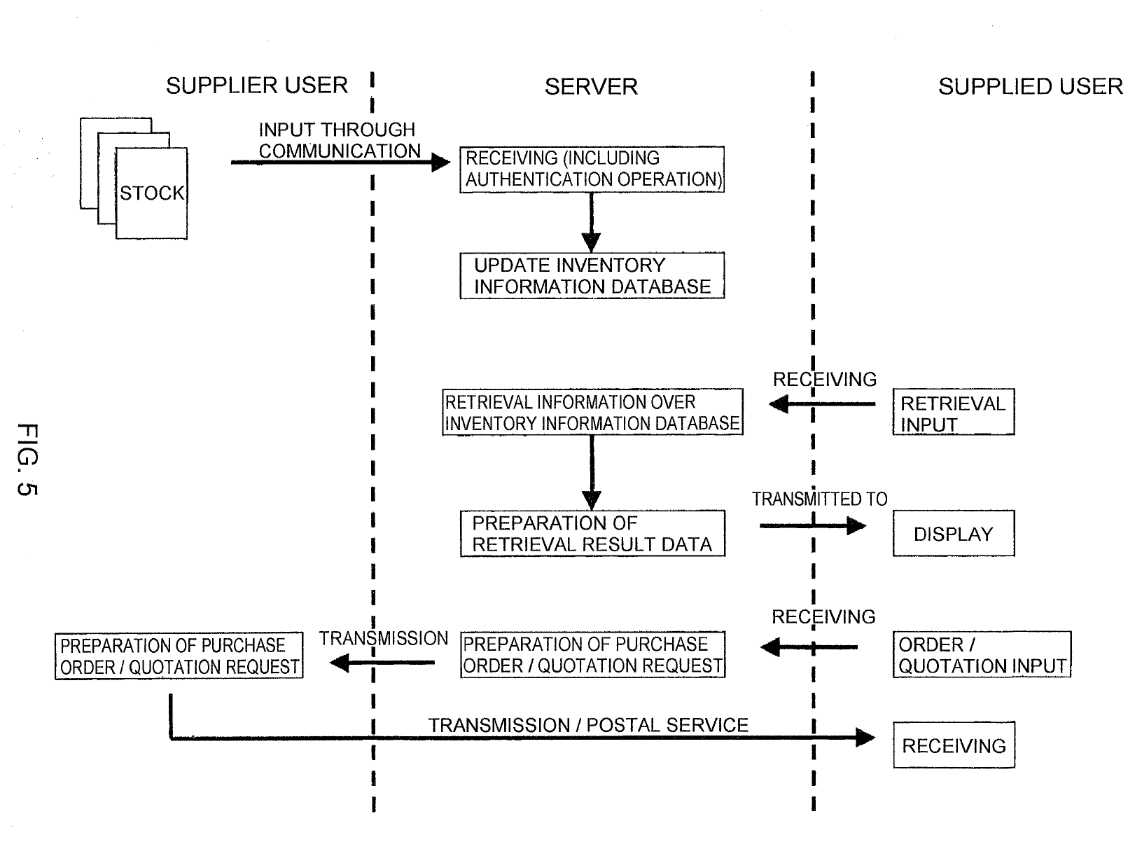

By reference to FIGS. 5 through 7, there is roughly described the flow of operations by which the supplier user enters inventory information about semiconductor parts to the WEB server 7 and by which the WEB server 7 compiles the inventory information into a database on the basis of the result of input of inventory information, thereby enabling a supplied user to retrieve desired inventory information and thus providing a retrieval result to the supplied user.

As represented by FIG. 5, the supplier user extracts inventory information to be registered into the server 7 from a ledger or management database which manages inventory information to be registered into the server 7. The thus-extracted inventory information is supplied to the server 7 via the communications networks 2 and 6. At this time, the control section of the server 7 performs an authentication operation for authenticating whether or not the supplier user who has established connection with the server 7 and attempts to enter inventory information is authentic, through use of the previously-stored ID code and password.

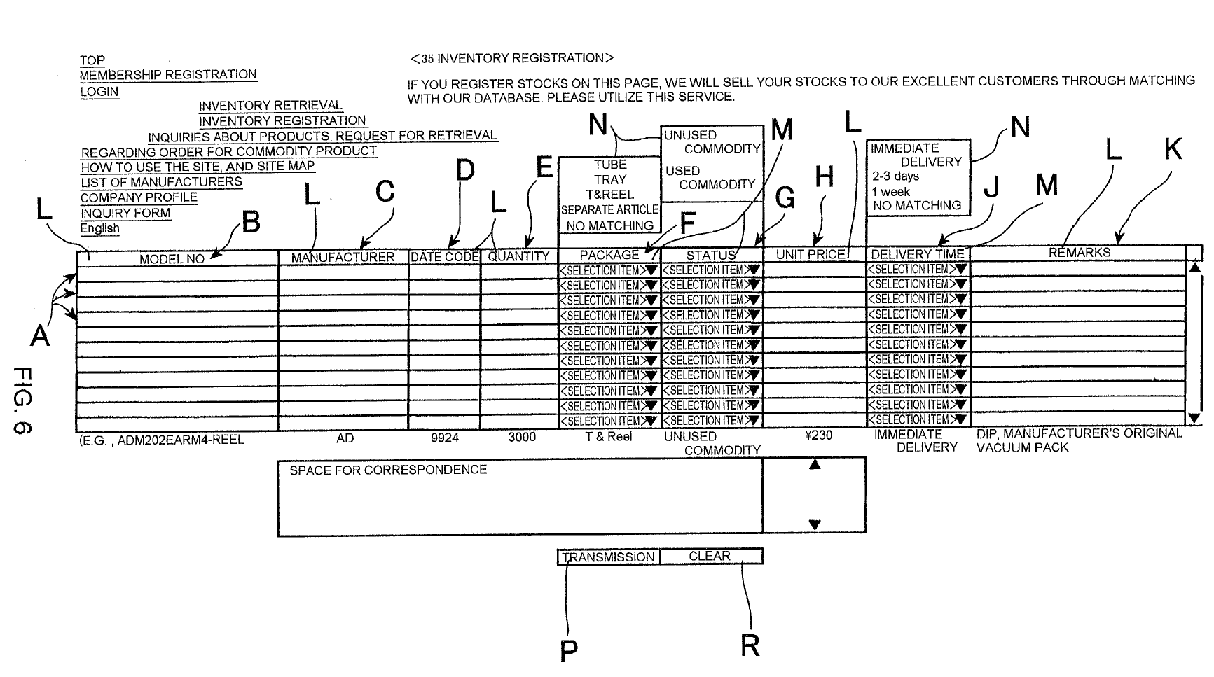

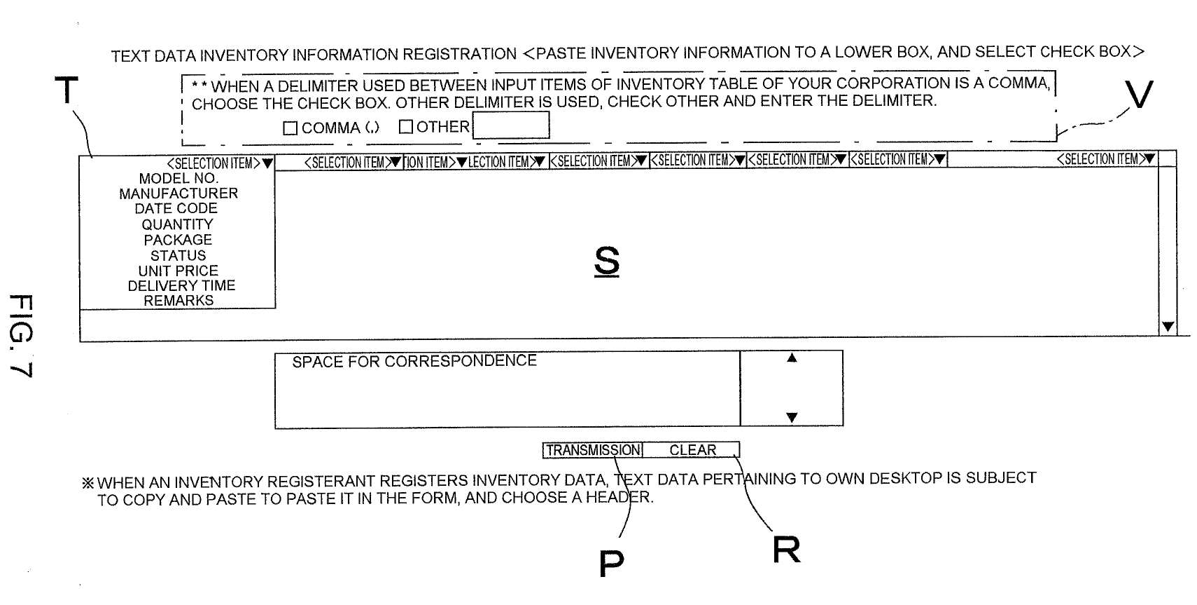

As shown in FIGS. 6 and 7, completion of authentication is followed by an input item display screen serving as a WEB page by way of which a user can enter information by means of the input operation section 13 or 25 of the WEB terminal 4.

As shown in FIG. 6, the server 7 sets a plurality of input items B, C, D, E, F, G, H, J, and K (consisting of a plurality of single matters) for each “certain semiconductor part” A. A plurality of input items pertaining to a “certain semiconductor part” A will now be described more specifically. Here, reference symbol B denotes a model number representing a commodity model; C denotes a manufacturer representing the name of a commodity manufacturer; D denotes a date code representing a date of manufacturer; E denotes quantity representing the quantity of stock; F denotes a package representing a packaged status of commodity; G denotes the status of stock; H denotes a unit price; J denotes a delivery time; and K denotes a remark to be used for describing a packaged status of commodity in more detail. Each of the input items B, C, D, E, F, G, H, J, and K is partitioned as a single item display (i.e., a cell). These displays are provided in a display section of the WEB terminal 4.

Inventory information representing a “certain semiconductor part” A, which is one of inventory information items, consists of a set of cells. The displays are arranged within a predetermined field in the form of a row in the sequence of input items. The server 7 arranges headers L and M above the thus-partitioned displays as input item types beforehand.

The supplier user performs input operation for filling in the respective input items on the WEB page having the input item displays arranged thereon in the manner mentioned above, by means of operation of the input operation section of the WEB terminal 4. In this way, entry of inventory information is completed.

A manner of filling in input items assigned headers L is different from a manner of filling in input items assigned headers M. Headers L and M correspond to header information for informing the supplier user of what form of character information is to be input, such as characters, letters, or numerals which cannot be changed by means of operation of the input operation section 13 or 25 of the WEB terminal 4. The header information is displayed by way of the display section 14 or 24 of the WEB terminal 4.

Entry of information into an input item display assigned the header L is performed in the following steps. Namely, the supplier user ascertains what information is to be input while viewing the character information represented by the header L on the display section 14 or 24 of the WEB terminal 4. Of the inventory information which is possessed by the supplier user and corresponds to the header L, a single matter pertaining to a “certain semiconductor part” A is entered by way of the input operation section 13 or 25 on the WEB terminal 4.

Entry of information into the input item display assigned the header M is performed in the following manner. Character information to be input to each of the input items is predictable, and the expression of the character information may differ from one supplier user to another supplier user. All input items which can be predicted as input items are displayed in the position of an input item to which input of information is to be performed. More specifically, the input items are displayed within a type selection display window N which is displayed by means of movement of a mouse pointer appearing in the display section 14 or 24 as a result of operation of the input operation section 13 or 25 such as a mouse. A desired input item is selected from the thus-displayed input items by means of the input operation section 13 or 25, and entry of information to the input item is performed. Hence, an individual supplier user can be prevented from entering different character information into the same input item, which would hinder compilation of the information into a database.

As mentioned above, a plurality of input items are arranged in a row in the form of partitioned cells for each semiconductor part. The supplier user individually inputs information into the input items previously arranged in the form of partitioned cells by way of the WEB terminal 4. When entry of information into all the input items has been completed, the supplier user clicks a transmission button P through use of a mouse by means of actuation of the input operation section 13 or 25. The thus-input inventory information is input and transmitted to the server 7. If the supplier user does not desire to transmit the thus-entered information, the user clicks a clear button R by use of the mouse, thereby clearing all the entered information items. The user can then enter information again. The input screen serving as the WEB page such as that shown in FIG. 6 has been employed hitherto. In the case of a semiconductor part illustrated in the present embodiment, in order to sufficiently disclose to supplied users inventory information about a certain semiconductor part, the inventory information consisting of a plurality of input items is made up of a plurality of types of character information items, such as letters, numerals, or symbols. Thus, the inventory information is very vulnerable to entry failures. For this reason, facilitation of input operation for entering inventory information is desired.

In the present embodiment, as can be seen from the WEB page shown in FIG. 7, in order to reduce the amount of inventory information consisting of a plurality of input items for sufficiently disclosing inventory information about a certain semiconductor part to supplied users, an input display screen differing from that shown in FIG. 6 is posted on the WEB page.

FIG. 7 shows an input display screen serving as a WEB page which enables entry of information in a manner differing from that required in the case of the input display screen shown in FIG. 6. A non-partitioned single input field S is formed for a plurality of input items (corresponding to the single matters). Input item information which relates to the input items and has been prepared beforehand in a predetermined form such as a text form is collectively input to the input field S by means of pasting operation by way of the WEB terminal.

Information which has been prepared beforehand by the supplier user through use of Excel (spreadsheet software) and has been converted into text data is employed as the “input item information which relates to the input items and has been prepared beforehand in a predetermined format such as a text format.”

The control section of the server 7 including the guide program controls the layout of types of input items at the time of collective input of information into the partitioned input fields such that a display of input items to be selected by the supplier user and a type selection display window T-which serves as a single matter display window and enables selection of one from the input item types. The control is effected by means of operating the mouse by way of the input operation section 13 or 25, to thereby move the mouse pointer U to symbol ∇ and clicking the symbol so that the type selection display window appear in a location above a paste field in the input field S.

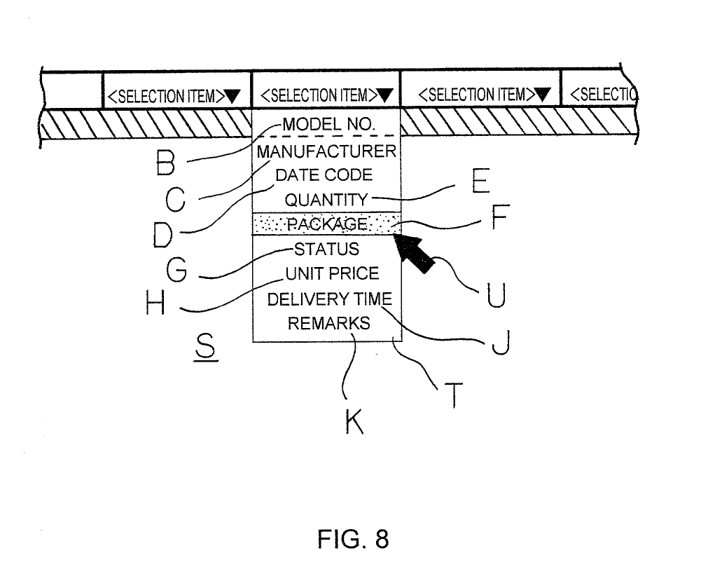

As shown in FIG. 8, a list of input items B, C, D, E, F, G, H, J, and K, each pertaining to a single matter, are displayed in the type selection display window T. The control section including the guide program prompts the user to select one input item by way of the WEB terminal 4 by means of moving the mouse pointer U over the input items in the list.

As shown in FIG. 8, at the time of selection of an input item, an input item where the mouse pointer U is situated is highlighted, thus enabling the user to view what the mouse pointer U specifies, by way of the display section of the WEB terminal 4.

A plurality of input items—for which input item information pertaining to a plurality of input items have been collectively input through pasting operation—are pasted in a columnar pattern to the hatched position shown in FIG. 8 as inventory information pertaining to a “certain semiconductor part” A. Then, input type representing the nature of a single matter is selected with regard to each of the thus-pasted input items by means of the input operation section 13 or 25 of the WEB terminal 4.

As illustrated in an input display screen serving as a WEB page shown in FIG. 7, a delimiter is input by way of the input operation section 13 or 25 of the WEB terminal 4 in accordance with a display V for “prompting input of a delimiter.” On the basis of the input, for each unit input item, the control section ascertains break points among the plurality of input items—for which input item information pertaining to a plurality of input items has been collectively input through pasting operation. As a result, inventory information can be extracted as information associated with an input type, as required, through retrieval of the database 34 by way of the WEB terminal 4 of the supplier user. As shown in FIG. 5, information is input to the plurality of input items, and the transmission button P shown in FIGS. 7 and 8 is clicked. The inventory information data base is updated by means of a control operation of the control section of the server 7.

On the basis of the inventory information which is stored in the thus-updated inventory information database and has been supplied from the supplier users, a supplied user retrieves a desired semiconductor part by means of operation of the WEB terminal 4 owned by the supplied user. The control section of the server 7 produces a retrieval result and transmits display information for causing the display section 14 or 24 of the WEB terminal 4 owned by the supplied user to display in a desired format the produced retrieval result.

Subsequently, a purchase order form or quote request form is exchanged between a supplier user and a supplied user in an electronic form or by way of postal service, thereby finally enabling signing of a deal.

In the present embodiment, an input screen shown in FIG. 7 enabling collective input of a plurality of input items through a pasting operation and a related-art input screen shown in FIG. 8 which enables manual input of information are adopted as a WEB page on which a plurality of input items are to be input. Entry of information can be performed, by means of selecting an input method so as to suit the convenience of supplier users who desire to register their stocks.

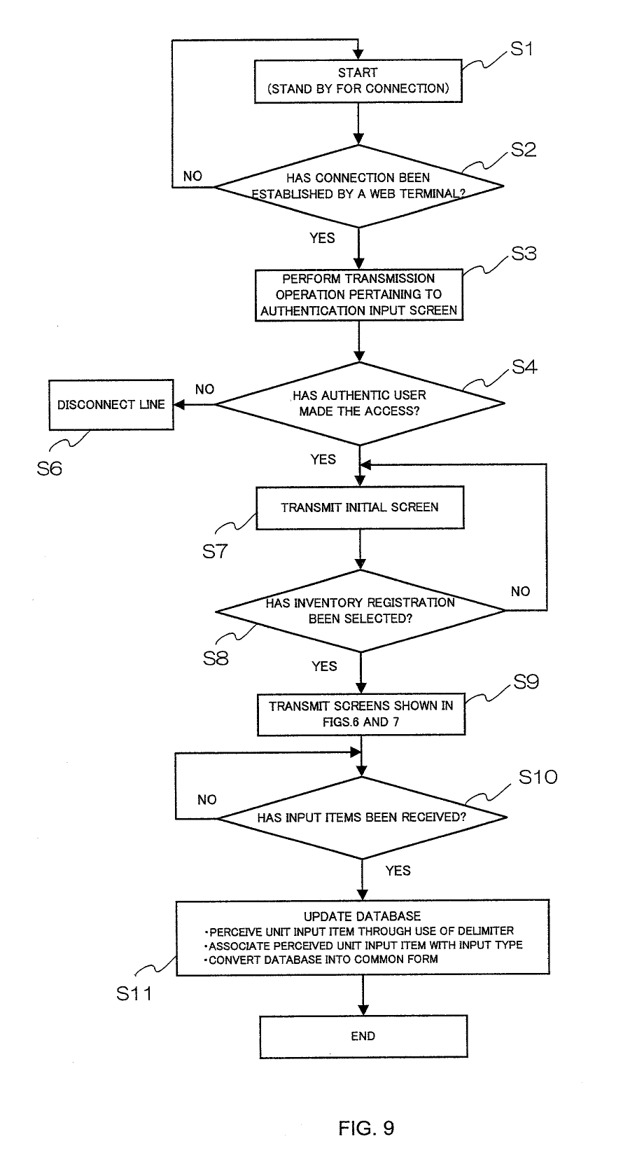

FIG. 9 is a flowchart showing the flow of processing to be performed within the server 7 when entry of electronic information about the inventory information shown in FIGS. 5 through 8 is performed. There may be slight overlap between the flowchart and that shown in FIG. 5. The flow of detailed processing to be performed in the server 7 will now be described by reference to the flowchart.

The server 7 is in a standby condition for receiving an access from a user by way of a WEB terminal 4 (step S1).

A determination is made as to whether or not an access has been made by way of a WEB terminal 4 (step S2).

After establishment of connection between the WEB terminal 4 and the server 7 has been ascertained, an authentication input screen for authenticating whether or not an authentic user has made an access is sent to the WEB terminal 4 which has made the access, thereby prompting a user to enter an ID code and a password assigned to a user (step S3).

On the basis of the received authentication input screen, the user enters an ID code and a password, imparted from the server 7, into the WEB terminal 4 by means of the input operation section 13 or 25. The thus-input ID code and password are transmitted to the server 7 (step S4).

The control section of the server 7 performs a comparison and authentication operation for comparing the received ID code and the password with an ID code and a password which have been stored in the memory 32 beforehand (step S5).

If a result of authentication shows unauthorized use of the ID code and password, the line is disconnected (step S6).

If the control section of the server 7 has determined on the basis of the authentication result that an authorized user has made the access, an initial screen is sent to the WEB terminal. On the initial screen are displayed all the services offered by the server 7, and the user can select a desired one from the thus-displayed services at his/her own will (step S7).

As is evident from jump input items shown in FIG. 6, there can be offered services such as “Membership Registration,” “Stock Retrieval,” and “Stock Registration.” The present embodiment will now describe a case where a service “Stock Registration” has been selected. Further description of other services is omitted.

When the control section of the server 7 has determined from the initial screen that the service “Stock Registration” has been selected by the user by way of the WEB terminal 4, there is transmitted the electronic information for displaying an input item display screen serving as a WEB page which enables entry of the inventory information shown in FIGS. 6 and 7 by way of the input operation section 13 or 25 of the WEB terminal 4 (step S9).

In the present embodiment, the user starts up Excel (product name of spreadsheet software) while glancing at the input item display screen displayed on the display section 14 or 24. The inventory information previously stored as Excel electronic information is displayed in another window. The inventory information in the form of Excel data to be posted on the WEB page is converted into a text format. The user is then prompted to paste the thus-converted text data into a single input field on the input item display screen by means of a copy or cut/paste function. Further, the user is prompted to enter whether delimiters provided among the plurality of input items pertaining to inventory information are spaces, commas, or other symbols, by way of the input operation section 13 or 25. Further, the user is prompted to select an appropriate one from a plurality of input types provided in the type selection display window T for each of the input items pertaining to the inventory information. The control section of the server 7 including the guide program performs the above-described prompting operations.

When the input item display screen is transmitted to the server 7 after completion of input operation, a determination is made as to whether or not the thus-transmitted information has been received appropriately. A determination as to whether or not the information has been received appropriately means a determination as to whether the received input items are complete or incomplete or whether the transmitted data are of predetermined format, such as a text format, which can be edited by the server 7 as a database (step S10).

If the result of determination has been determined to be adequate, the control section of the server 7 converts the data into a format matching the inventory information database 34 which has been constructed as inventory information beforehand. In other words, the data are input to the input field S by means of a pasting function. Hence, input orders for pasted input items relating to inventory information may differ from those of another user. On the basis of a symbol input to the delimiter display V, the entered information is separated for each single input item. Further, input type of the information is ascertained. Finally, the data are converted such that an identical input format is provided to all the users.

Database software, such as Excel of Microsoft Corporation, has the function of specifying a delimiter and automatically converting data produced by other relevant software. Thus, data may be automatically converted in the same manner (step S11)

As mentioned above, an operation flow relating to registration of inventory information is completed.

According to the present invention, data are input to a server through pasting operation by utilization of the data prepared by a user beforehand. Hence, data entry is greatly improved in working efficiency as compared with data entry which has hitherto been performed by way of a terminal.

Even when the layout of previously-prepared data may change from one user to another user, a user who is to perform pasting operation is caused to select the type of input item (i.e., a single matter) at the time of pasting of a plurality of input items (single matters). Hence, there is yielded an advantage of the ability to facilitate compilation of data into a database.

1. A server which is connected to a plurality of terminals and exchanges data with the terminals, wherein
a display screen of each of the terminals displays a paste field to which a multiple item display made up of a set of single item displays, each representing a single matter, is to be pasted, and a single matter display window which enables selection of a single matter corresponding to a single item display included in the multiple item display and definite display of the selected single matter.

2. The server according to claim 1, wherein the multiple item display is made by means of arranging a plurality of single item displays in a row.

3. An input control method which enables collective input of input item information pertaining to a plurality of input items prepared in a predetermined format, such as a text format, on a WEB page by means of operation of a WEB terminal, the method comprising the steps of:
prompting entry of a delimiter for a plurality of input items at the time of collective input of the input item information, thereby distinguishing the input delimiter and enabling perception of the collectively-input a plurality of items in a divided manner on a per input item basis.

4. An input control method comprising an operation for preparing, beforehand, a plurality of input items to be input in a predetermined format, such as a text format, on a WEB terminal as input item information formed by consecutively arranging the input items in no particular order, and an operation for enabling collective input of the plurality of input items in a row on a WEB page of a WEB server connectable to the WEB terminal by way of the Internet, through pasting operation of the WEB terminal, wherein
a plurality of type selection display windows equal in number with the input items are arranged in parallel with the input items in the vicinity of an input field where the input items are to be collectively input in a row, and
for each of the input items collectively input in the form of a row, type is input to the corresponding type selection display window.

5. An input control method which enables collective input of input item information constituted of a plurality of input items previously prepared for placing an order for products by a WEB terminal into a WEB page from the WEB terminal in a predetermined format, such as a text format, through a pasting operation at the time of input of the input items into the WEB page of a WEB server by way of the WEB terminal, wherein
the input items mixedly comprise a plurality of types of input item information items, such as numbers, alphabets, letters, or Japanese Katakana characters; more specifically, product numbers, unit prices, quantities, and delivery times, and there is a possibility of the input items being consecutively arranged in a different order by each of the WEB terminals;
the WEB server prompts the user of the WEB terminal to enter a delimiter for the plurality of input items at the time of collective input of input items and can separately perceive the collectively-input input items on a per-unit input item basis by means of subjecting the input delimiter to discrimination processing; and
the WEB server arranges type selection display windows for use in selectively inputting input type, which windows are equal in number with the input items, in the vicinity of an input field on the WEB page where the input types of the input items are collectively input in a row during the collective input of input items, thereby prompting selective input of input type into the type selection window by way of the WEB terminal, and converts input information into a format formed by arrangement of uniform input items in accordance with the input type entered in the type selection display window, for ensuring consistency with information entered into the WEB page from another WEB terminal.

6. A storage medium having recorded thereon a program capable of executing an input control method which enables collective input of input item information pertaining to a plurality of input items prepared in a predetermined format, such as a text format, on a WEB page by means of operation of a WEB terminal, the method comprising the steps of:
prompting entry of a delimiter for plurality of input items at the time of collective input of the input item information, thereby distinguishing the input delimiter and enabling perception of the collectively-input input items in a dividing manner on a per input item basis.

7. A storage medium having recorded thereon a program capable of executing an input control method comprising an operation for preparing, beforehand, a plurality of input items to be input in a predetermined format, such as a text format, on a WEB terminal as input item information formed by consecutively arranging the input items in no particular order, and an operation for enabling collective input of the plurality of input items in a row on a WEB page of a WEB server connectable to the WEB terminal by way of the Internet, through pasting operation of the WEB terminal, wherein
a plurality of type selection display windows equal in number with the input items are arranged in parallel with the input items in the vicinity of an input field where the input items are to be collectively input in a row, and
for each of the input items collectively input in the form of a row, type is input to the corresponding type selection window.

8. A storage medium having recorded thereon a program capable of executing an input control method which enables collective input of input item information constituted of a plurality of input items previously prepared for placing an order for products by a WEB terminal into a WEB page from the WEB terminal in a predetermined format, such as a text format, through a pasting operation at the time of input of the input items into the WEB page of a WEB server by way of the WEB terminal, wherein
the input items mixedly comprise a plurality of types of input item information items, such as numbers, alphabets, letters, or Japanese Katakana characters; more specifically, product numbers, unit prices, quantities, and delivery times, and there is a possibility of the input items being consecutively arranged in a different order by each of the WEB terminals;
the WEB server prompts the user of the WEB terminal to enter a delimiter for the plurality of input items at the time of collective input of input items and can separately perceive the collectively-input input items on a per-unit input item basis by means of subjecting the input delimiter to discrimination processing; and
the WEB server arranges type selection display windows for use in selectively inputting input type, which windows are equal in number with the input items, in the vicinity of an input field on the WEB page where the input types of the input items are collectively input in a row during the collective input of input items, thereby prompting selective input of input type into the type selection window by way of the WEB terminal, and converts input information into a format formed by arrangement of uniform input items in accordance with the input type entered in the type selection display window, for ensuring consistency with information entered into the WEB page from another WEB terminal.

9. A WEB server which enables entry of electronic information from another WEB terminal by way of a communication line, such as the Internet, the server comprising
control means for effecting the operations of:
enabling collective input of input item information pertaining to a plurality of input items prepared in a predetermined format, such as a text format, on a WEB page by means of operation of a WEB terminal, while connection to the WEB terminal and authentication are taken as conditions;
prompting entry of a delimiter for plurality of input items at the time of collective input of the input item information; and
distinguishing the input delimiter and enabling perception of the collectively-input input items in a divided manner on a per input item basis.

10. A WEB server which enables entry of electronic information from another WEB terminal by way of a communication line, such as the Internet, the server comprising
control means for effecting the operations of:
enabling collective input of input item information which has been prepared beforehand on a WEB terminal and is formed by means of consecutively arranging in no particular order a plurality of input items to be input in a predetermined format, such as a text format, on a WEB page of the WEB server by means of operation of the WEB terminal and through pasting operation while connection to the WEB terminal and authentication are taken as conditions;
displaying on a display section of the WEB terminal a plurality of type selection display windows which are equal in number with the input items and are arranged in parallel with the input items in the vicinity of an input field where the input items are to be collectively input in a row;
prompting input of, to each of the type selection display windows, type of the corresponding input item among the input items collectively input in the form of a row; and
storing the input type selectively input to the type selection display window in association with a corresponding input item.

11. A WEB server which enables entry of electronic information from another WEB terminal by way of a communication line, such as the Internet, the server comprising
control means for effecting the operations of:
prompting collective input of input item information constituted of a plurality of input items previously prepared for placing an order for products by a WEB terminal into a WEB page from the WEB terminal in a predetermined format, such as a text format, through a pasting operation at the time of input of the input items into the WEB page of a WEB server by way of the WEB terminal while connection to the WEB terminal and authentication are taken as conditions; and wherein
the input items mixedly comprise a plurality of types of input item information items, such as numbers, alphabets, letters, or Japanese Katakana characters; more specifically, product numbers, unit prices, quantities, and delivery times, and there is a possibility of the input items being consecutively arranged in a different order by each of the WEB terminals; and
the control means prompts the user of the WEB terminal to enter a delimiter for the plurality of input items at the time of collective input of input items and can separately perceive the collectively-input input items on a per-unit input item basis by means of subjecting the input delimiter to discrimination processing; and
the control means transmits to the WEB terminal an image showing type selection display windows for use in selectively inputting input type, which are equal in number with the input items and are arranged in the vicinity of an input field on the WEB page where the input types of the input items are collectively input in a row during the collective input of input items, thereby prompting selective input of input type into the type selection window by way of the WEB terminal, and converts input information into a format formed by arrangement of uniform input items in accordance with the input type entered in the type selection display window, for ensuring consistency with information entered into the WEB page from another WEB terminal.
